(19) United States
(12) Patent Application Publication
(10) Pub. No.: US 2010/0203340 A1
(43) Pub. Date: Aug. 12, 2010

(54) PROTECTIVE CARBON COATINGS

(76) Inventors: Rodney S. Ruoff, Austin, TX (US); Richard Piner, Austin, TX (US); Xuesong Li, Austin, TX (US); Weiwei Cai, Austin, TX (US)

Correspondence Address: Ballard Spahr LLP, SUITE 1000, 999 PEACHTREE STREET, ATLANTA, GA, 30309-3915, US

(21) Appl. No.: 12/702,821

(22) Filed: Feb. 9, 2010

Related U.S. Application Data
(60) Provisional application No. 61/151,069, filed on Feb. 9, 2009.

(51) Int. Cl. B32B 15/04; B05D 5/00; C23C 8/64

(52) U.S. Cl. 428/408; 427/287; 148/206; 977/734

(57) ABSTRACT

Disclosed is a method for forming a protective coating comprising contacting a carbon material with a metal surface, heating the carbon material and metal to allow at least a portion of the carbon material to dissolve in the metal, diffuse across a portion of the metal surface, or a combination thereof, and then cooling the metal and carbon material to form a metal having a protecting carbon coating disposed on a surface thereof, wherein the protective coating comprises graphene, multi-layer graphene, or a combination thereof. Also disclosed are a method for inhibiting corrosion comprising forming a layer of graphene on at least a portion of a metal surface; a metal having a surface, wherein at least a portion of the surface comprises a protective carbon coating comprising graphene, multi-layer graphene, or a combination thereof; and a passivation coating comprising a graphene, multi-layer graphene, or a combination thereof.

### CROSS REFERENCE TO RELATED APPLICATIONS

This application claims priority to U.S. Provisional Patent Application Ser. No. 61/151,069, filed on Feb. 9, 2009, the entire contents of which are incorporated by reference herein.

### BACKGROUND

1. Technical Field

The present disclosure relates to carbon coatings, and specifically to protective carbon coatings for use on metals.

2. Technical Background

The use of refined metals is widespread, but such metals can frequently be chemically reactive, limiting their use or requiring protective coatings. Protecting the surface of such reactive metals has developed into a significant industry.

Conventional approaches to protecting metal surfaces can include organic coatings, paints, varnishes, polymer coatings, formation of oxide layers, anodization, chemical modification, such as the formation of sulfate and/or thiol layers, and coating, for example, via electroplating, with other metals or alloys.

Such conventional approaches can suffer from a variety of limitations, such as susceptibility of heat damage, necessity of thick coatings, cost, formation of waste products, etc. Thus, there is a need to address the aforementioned problems and other shortcomings associated with traditional metals and coatings. These needs and other needs are satisfied by the compositions and methods of the present disclosure.

### SUMMARY

In accordance with the purpose(s) of the invention, as embodied and broadly described herein, this disclosure, in one aspect, relates to carbon coatings, and specifically to protective carbon coatings for use on metals.

In a first aspect, the present disclosure provides a method for forming a protective coating, the method comprising contacting a carbon material with at least a portion of a metal having a surface; heating the contacted carbon material and metal at a temperature and for a time sufficient to allow at least a portion of the carbon material to dissolve in the metal, diffuse across a portion of the metal surface, or a combination thereof; and then cooling the metal and carbon material to form a metal having a protective carbon coating disposed on at least a portion of a surface thereof; wherein the protective coating comprises graphene, multi-layer graphene, or a combination thereof.

In a second aspect, the present disclosure provides a method for inhibiting corrosion, the method comprising forming a layer of graphene on at least a portion of a metal surface.

In a third aspect, the present disclosure provides a metal having a surface, wherein at least a portion of the surface comprises a protective carbon coating comprising graphene, multi-layer graphene, or a combination thereof.

In a fourth aspect, the present disclosure provides a passivation coating comprising a graphene, a multi-layer graphene, or a combination thereof.

### BRIEF DESCRIPTION OF THE FIGURES

The accompanying figures, which are incorporated in and constitute a part of this specification, illustrate several aspects and together with the description serve to explain the principles of the invention.

FIG. 1 depicts unprotected (A) and protected (B) copper foils prior to heating in an oxidizing environment.

FIG. 2 depicts unprotected (A) and protected (B) copper foils after heating in an oxidizing environment.

FIG. 3 depicts a protected copper alloy ball before (A) and after (B) heating to 200° C. in air for 18 hours, in accordance with the various aspects of the present invention.

FIG. 4 depicts an unprotected copper alloy ball before (A) and after (B) heating to 200° C. in air for 18 hours.

FIG. 5 is a an image of solder on graphene protected copper.

FIG. 6 is a scanning electron micrograph illustrating a metal surface having coated areas and uncoated area comprising an oxide.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited.

### A. Definitions

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described.

As used in the specification and the appended claims, the singular forms “a,” “an” and “the” include plural referents unless the context clearly dictates otherwise. Thus, for example, reference to “a metal” includes mixtures of two or more metals.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or can not occur, and that the description includes instances where said event or circumstance occurs and instances where it does not.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

In one aspect, the present disclosure is directed to the formation of protective carbon layers and/or coatings on metal surfaces. In another aspect, certain carbon materials can dissolve into metals at elevated temperatures. In another aspect, certain carbon materials can diffuse across a portion of a surface of a metal at elevated temperatures. When the resulting metal is cooled in the absence of oxygen, the solubility of the dissolved carbon can decrease and the carbon can diffuse to the metal surface, forming a carbon layer. In yet another aspect, a protective layer and/or coating comprising graphene can be formed on the surface of a metal. In such an aspect, and not wishing to be bound by theory, a graphene layer can be formed on a portion of a metal surface via surface diffusion and catalytic action of the metal surface.

As briefly described above, the present disclosure provides a protective carbon layer on a metal surface. In another aspect, the present disclosure provides a method for growing a protective carbon coating on the surface of a metal, wherein the protective carbon coating is formed from the metal and other components dissolved or distributed therein. In various aspects, the protective carbon layer can comprise graphene, graphite, or a combination thereof. In other aspects, the protective carbon layer can comprise a single monoatomic layer of graphene, multilayers of graphene, or a combination thereof.

Some approaches have attempted to deposit graphene or graphite materials on the surface of a metal. Other approaches have attempted to form graphene films using collapsed single wall carbon Nanotubes (SWCNTs), but achieving conformal coatings with collapsed SWCNTs on metal surfaces is not possible. The use of SWCNTs will always leave gaps between even the closest packed SWCNTs where corrosion can occur.

In contrast, the present invention provides, in various aspects, thin graphene films that can conformally coat large areas with no or substantially no pinholes or defects. In another aspect, the methods of the present invention can remove all or substantially all oxides from a metal surface prior to introducing a carbon material from which a protective carbon coating can be formed.

In one aspect, the present invention provides a passivation layer that can block or at least partially block one or more chemical reactions from occurring at the protected metal surface. In another aspect, the protective layer of the present invention can resist attack by oxygen, mild acids, and/or mild bases.

In one aspect, the metal of the present invention can be any metal, alloy, combination of metals, or combination thereof suitable for forming a protective carbon coating on at least a portion of a surface thereof. In various aspects, the metal can comprise a transition metal. In various specific aspects, the metal can comprise, copper, nickel, iron, a stainless steel, an Incanel alloy, or a combination thereof. In one specific aspect, the metal comprises copper and/or a copper alloy.

In one aspect, the metal of the present invention can comprise any physical form suitable for use in the methods described herein and/or in a desired application. In a specific aspect, the metal comprises a metal foil, such as, for example, a thin metal foil. In another aspect, the metal comprises a sheet or planar material. In yet other aspects, the metal comprises a block, formed metal article, wire, screen, tube, electrode, or a combination thereof.

In one aspect, a metal surface can optionally be prepared and/or cleaned prior to the formation of a protective carbon layer. Any suitable technique can be employed for preparing such a surface, including, physical and/or chemical means. In one aspect, a metal can be subjected to a reducing atmosphere to remove all or a portion of an oxide that can be present on the metal surface.

The formation of a protective carbon layer can be accomplished using a variety of approaches, including, but not limited to, those recited herein. In one aspect, a carbon, such as in the form of a hydrocarbon, can be contacted with a metal surface. In another aspect, a carbon, such as a powdered carbon or carbon containing material can be contacted with at least a portion of a metal surface. In another aspect, a gaseous hydrocarbon can be contacted with a metal surface. In yet another aspect, a carbon and/or carbon containing material can be contacted with at least a portion of a metal in an inert or reducing atmosphere.

In another aspect, a carbon containing material, such as, for example, a colloidal suspension, can be contacted with a metal surface. In yet another aspect, an electrochemical technique can be used to deposit a carbon or carbon containing material on a metal surface. In still other aspects, a carbon material can be contacted with at least a portion of a metal surface via a chemical vapor deposition method, an ion implantation method, or other suitable technique. It should be understood that the specific carbon material and method of contacting can vary, and that the present invention is not intended to be limited to any particular carbon or method of contacting, provided that a protective carbon coating can be formed.

The carbon material or carbon containing material can vary depending upon the specific method of contacting, metal surface, and desired properties of the resulting protected surface. In one aspect, the carbon material comprises a hydrocarbon. In another aspect, the carbon material comprises a gaseous hydrocarbon. In still another aspect, the carbon material comprises a powdered carbon. The carbon material or carbon containing material can comprise any one or more individual carbon materials, and the specific composition, physical properties, and chemical properties of any one or more such individual carbon materials can vary. In a specific aspect, the carbon material comprises methane.

In one aspect, the carbon material or carbon containing material, after contacting with at least a portion of the metal surface and optionally heating, can form a discrete carbon coating, an alloy, such as, for example, between the metal and the carbon material, a carbide, or a combination thereof. In other aspects, the carbon material can form other compounds depending on the specific compositions and methods employed.

In one aspect, the carbon material or carbon of a carbon containing material should be capable of at least partially dissolving in at least a portion of the metal. In another aspect, the carbon material or carbon of a carbon containing material should be capable of completely dissolving in the metal. In another aspect, the carbon material or carbon therein should be capable of catalytically interacting with a metal surface and diffusing across at least a portion thereof. It should be understood that the concentration of carbon material and the volume of metal can affect the ability of a carbon material to dissolve therein, and the present invention is not limited to any particular carbon concentration or to a carbon material having any specific solubility.

In one aspect, the carbon material can be contacted uniformly or substantially uniformly across the metal surface to be protected, such that, after heating, the carbon can diffuse uniformly through the metal and/or across the surface of the metal, and ultimately provide a uniform protective carbon coating. In another aspect, the carbon material can be contacted uniformly or substantially uniformly across the metal surface to be protected, such that, after heating, at least a portion of the carbon can diffuse through the metal. In another aspect, the carbon material can be contacted uniformly or substantially uniformly across the metal surface to be protected, such that, after heating, at least a portion of the carbon can diffuse across the surface of the metal. In another aspect, the carbon material can be contacted so as to provide greater amounts of carbon in one or more portions of the metal and lesser amounts of carbon in other portions of the metal.

The amount of carbon material to be contacted with a metal surface can vary depending upon the nature of the specific carbon material and metal, and the desired properties of the resulting protected metal surface. In one aspect, the amount of carbon material contacted with a metal should be sufficient to allow the formation of at least a monoatomic layer of carbon, such as, for example, graphene, on at least a portion of the metal surface. In another aspect, the amount of carbon material contacted with a metal should be sufficient to allow the formation of at least a monoatomic layer of carbon, such as, for example, graphene, on all of or substantially all of a metal surface. In yet another aspect, the amount of carbon material contacted with a metal should be sufficient to allow the formation of a multi-atomic layer of carbon on at least a portion of the metal surface.

In one aspect, the specific metal and carbon material can be selected so as to provide a match in coefficients of thermal expansion (CTE). In one aspect, a metal and a carbon material can be selected so as to provide a protected surface wherein the metal and the protective coating have the same or substantially the same CTE. If a metal and carbon material are selected to provide a CTE match, it should be understood that it is not necessary that the respective CTE of each of the metal and the carbon material match exactly. Selecting a metal and a carbon material so as to provide a protected surface wherein the metal and the protective coating have the same or substantially the same CTE can provide greater mechanical durability and reduce and/or eliminate the likelihood that a coating will delaminate, spar, wrinkle, or otherwise become unattached to the metal surface.

The inert or reducing environment in which a carbon material can be contacted with a metal surface can vary depending upon the specific components and desired properties of the resulting protected surface. In one aspect, contacting can be performed in an environment that is free from or substantially free from oxygen. In another aspect, contacting can be performed in an environment that is free of or substantially free of an oxidizing species. In yet another aspect, contacting can be performed in an inert environment, such as, for example, helium, nitrogen, argon, or a mixture thereof. In yet another aspect, contacting can be performed in a reducing environment, such as, for example, a hydrogen environment.

In one aspect, no additional techniques are employed to contact and/or deposit a carbon material on a metal surface. In another aspect, no plasma is used to etch and/or assist with bonding of a carbon material to the metal.

After contacting, the metal and contacted carbon material can be heated so as to allow at least a portion of the carbon material or a composition formed from the contacting to diffuse into and/or across a surface of at least a portion of the metal. The specific amount of heating (e.g., time and temperature) can vary depending upon the nature of the materials and desired amount of carbon to be dissolved and/or diffused. In various aspects, the time period in which an amount of carbon can diffuse into and/or across a surface of a metal can be on the order of minutes, such as, for example, from about 0.1 minutes to about 200 minutes, or about 0.1, 0.2, 0.5, 1, 2, 3, 4, 5, 6, 7, 8, 9, 10, 12, 14, 16, 18, 20, 25, 30, 35, 40, 45, 60, 90, 100, 110, 120, 130, 140, 150, 160, 170, 180, 190, or 200 minutes; or from about 0.5 to about 90 minutes, for example about 0.5, 1, 2, 3, 4, 5, 6, 7, 8, 9, 10, 11, 13, 15, 17, 19, 21, 23, 25, 27, 29, 31, 33, 35, 37, 39, 41, 43, 45, 47, 49, 51, 53, 55, 57, 59, 61, 63, 65, 67, 69, 71, 73, 75, 77, 79, 81, 83, 85, 87, 89, or 90 minutes. In other aspects, the amount of time can be less than about 0.1 minutes or greater than about 200 minutes, and the present invention is not intended to be limited to any particular period of time.

After heating, the metal having at least a portion of the carbon material dissolved therein and/or diffused across a surface thereof can be cooled or allowed to cool. For example, a graphene material grown on a copper surface can be, in one aspect, formed via a catalytic action at the metal surface. The rate of cooling can vary and can optionally be controlled, by for example, slow or rapid cooling. In a specific aspect, the metal can be cooled rapidly.

Upon cooling, at least a portion of the carbon material dissolved in or at the surface of a metal can segregate, for example, to a metal surface or a portion thereof. In one aspect, the amount of carbon material contacted and/or dissolved can be such that all of or substantially all of the carbon material segregates to a metal surface. In another aspect, the amount of carbon material contacted and/or dissolved can be such that at least a portion of the carbon material remains dissolved in the metal and/or segregated at a location other than a metal surface.

After cooling, the segregated carbon can form a protective coating on the surface of the metal. In one aspect, the protective carbon coating is continuous across all of or at least a desired portion of the metal surface. In another aspect, the protective carbon coating is discrete and does not completely or uniformly cover a metal surface.

In one aspect, at least a portion of the protective carbon coating comprises a single layer of graphene. In another aspect, at least a portion of the protective carbon coating comprises a multi-layer coating of graphene. Graphene, in various aspects, can comprise one-atom thick sheets of carbon. In one aspect, at least a portion of a graphene can be present in single atomic layer sheets. In another aspect, at least a portion of the graphene can be present in multilayer sheets, such as, for example, nanoplatelets. In yet another aspect, all or substantially all of the graphene is present in single atomic layer sheets.

A protective carbon coating formed in accordance with the various aspects of the present invention can, in various aspects, be resistant to or substantially resistant to heat damage. In another aspect, a protective carbon coating can be chemically inert. In yet another aspect, a protective carbon coating can block all of or a substantial portion of a gaseous or liquid from diffusion through the coating to the metal. In a specific aspect, a monoatomic layer of graphene can block the diffusion of helium and/or hydrogen species.

A protective carbon coating can thus protect the underlying metal from oxidation and/or chemical attack without significantly affecting the appearance and/or use of the metal. For example, a monoatomic layer of graphene will not, in various aspects, substantially affect the conductivity of the underlying metal.

A protective carbon coating can be useful in a wide variety of applications, such as, for example, printed circuit boards, lining steel food cans, plumbing and gas supply lines, aerospace applications, electronics, protecting metals used to make products for human consumption. For example, a protective carbon coating can, in various aspects, act as a flux, protecting an underlying metal surface from oxidation and promoting bonding between the underlying metal and another metal. Such an application can be useful in, for example, soldering electrical components wherein solder is applied to a conductive metal surface.

A protective carbon coating can be evaluated by subjecting a protected surface to, for example, oxidation. In one aspect, a protected metal surface can be heated in air or an oxidizing environment for a period of time sufficient to oxidize a similar unprotected metal. The protected metal surface can then be examined by visual, microscopic, and/or chemical means to determine if any chemical changes, for example, oxidation, have occurred, or if the protective carbon coating is continuous and defect free.

In one aspect, the protective carbon coating is electrically conducting or at least sufficiently electrically conductive to not adversely affect the conductivity of the underlying metal.

### B. Examples

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

1. Protection of Copper Foil

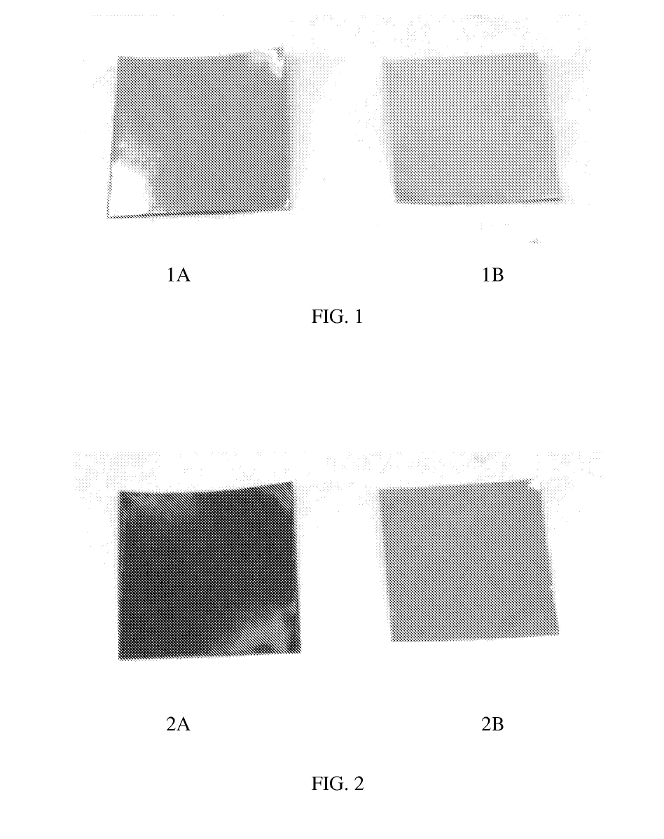

In a first example, unprotected (A) and protected (B) copper foils were heated in the presence of methane and argon, and subsequently cooled to room temperature. Images of the unprotected and protected copper foils prior to heating in an oxidizing environment are depicted in FIG. 1. After removing the foils from the reactor, they were placed on a hot plate and heated to about 200° C. for one hour. The resulting unprotected (A) and protected (B) foils are shown in FIG. 2. The images in FIG. 2 show that the unprotected foil has oxidized and darkened, while the protected foil shows no change in color.

2. Oxidation of Copper Alloy

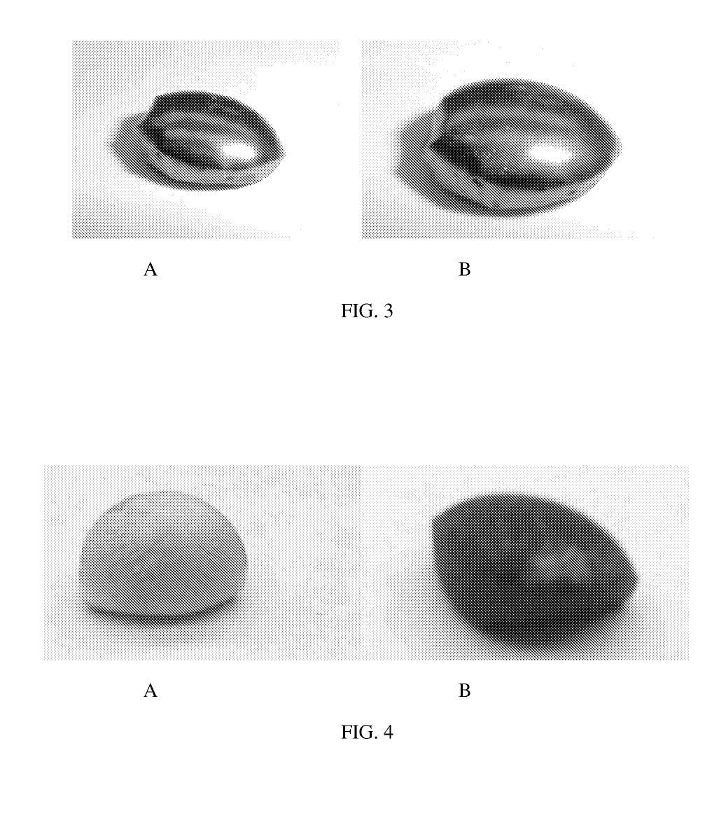

In a second example, protected and unprotected copper alloy balls were subjected to heating to 200° C. in air for 18 hours. FIG. 3 illustrates a copper alloy ball protected with a graphene coating in accordance with the present invention, both before (A) and after (B) heating to 200° C. in air for 18 hours. Even after exposure to a strong oxidizing environment, the surface of the protected copper alloy ball is still shiny. In addition, measurement of surface conductivity indicated that the surface remained very conducting after heating. In contrast, FIG. 4 illustrates an unprotected copper alloy ball both before (A) and after (B) heating to 200° C. in air for 18 hours. The formation of an oxide layer in the heated 4(B) image is clearly visible.

3. Solder Test

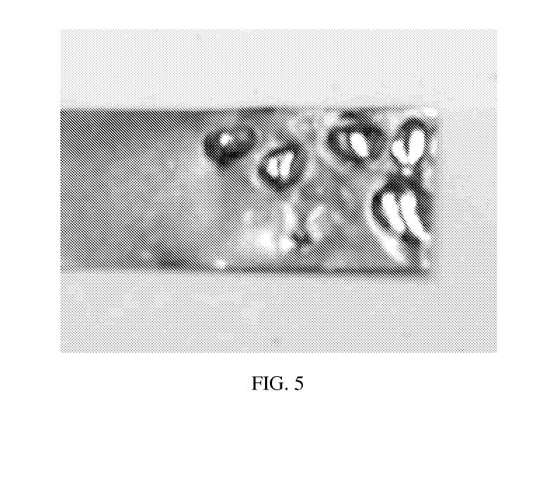

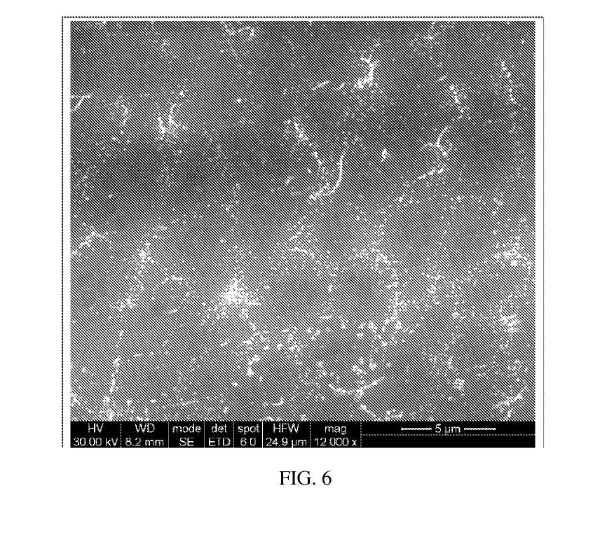

In a third example, solder was applied to piece of copper foil protected with a graphene layer in accordance with the present invention. The applied solder wetted the surface of the copper foil and flowed with less heat than when applied on a similar unprotected copper foil. While not wishing to be bound by theory, it is believed that the graphene coating serves as a flux, protecting the copper surface from oxidation and promoting the bonding of solder to copper, as illustrated in FIG. 5.

4. Examination of Film Defects

In a fourth example, a piece copper foil was coated with a sub-monolayer coating of graphene. The coated foil was then heated at 200° C. in air for three hours. A scanning electron micrograph of the resulting foil is depicted in FIG. 6. The micrograph has a number of small bright spots representing oxides formed on the surface in areas not protected by graphene. In contrast, protected areas of the surface, even with a single monoatomic layer of graphene appear unoxidized. Thus, even a single atom thick graphene coating can act as an effective diffusion barrier to oxidation.

5. Atomic Force & Scanning Tunnelling Microscopy

In a fifth example, a copper surface protected with a graphene coating, as described herein, was examined by an atomic force microscope in air. The surface of the copper, after coating, was annealed in a reducing atmosphere prior to examination. Under high magnification, the annealed surface had a pluarality of atomically flat steps. Such atomically flat steps are typically only observed in air on gold and platinum surfaces. The presence of such atomically flat steps on the protected copper surface indicate the strength and level of oxidation resistance of the graphene coating.

A similar graphene coated copper foil was also examined by scanning tunneling microscope. On unprotected metal foils, such as copper, imaging in air is typically impossible due to the presence of insulating oxides on the surface. Images were generated on the protected copper foil illustrating the stepped metal surface. The ability to acquire these images denotes that the underlying copper was protected from oxidation and had electrical conduction between the tip and metal, through the graphene coating.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for forming a protective coating, the method comprising:
a. contacting a carbon material with at least a portion of a metal having a surface;
b. heating the contacted carbon material and metal at a temperature and for a time sufficient to allow at least a portion of the carbon material to dissolve in the metal, diffuse across a portion of the metal surface, or a combination thereof; and then
c. cooling the metal and carbon material to form a metal having a protective carbon coating disposed on at least a portion of a surface thereof;
wherein the protective coating comprises graphene, multi-layer graphene, or a combination thereof.

2. The method of claim 1, wherein contacting occurs in an inert or reducing environment.

3. The method of claim 1, wherein the metal comprises copper, a copper alloy, or a combination thereof.

4. The method of claim 1, wherein the carbon material comprises a hydrocarbon.

5. The method of claim 1, wherein the carbon material comprises methane.

6. The method of claim 1, wherein the carbon material is present at a concentration sufficient to form a monoatomic layer of graphene on a surface of the metal after heating.

7. The method of claim 1, wherein the protective carbon coating is capable of inhibiting corrosion of the metal.

8. The method of claim 1, wherein the protective carbon coating is capable of passivating at least one of corrosion, reactivity, diffusion, or a combination thereof.

9. The method of claim 1, wherein the protective carbon coating has a coefficient of thermal expansion that is similar to and/or substantially similar to a coefficient of thermal expansion of the metal.

10. A method for inhibiting corrosion, the method comprising forming a layer of graphene on at least a portion of a metal surface.

11. The method of claim 10, wherein the layer of graphene comprises a monoatomic layer of graphene.

12. The method of claim 10, wherein the layer of graphene comprises a multiatomic layer of graphene.

13. A metal having a surface, wherein at least a portion of the surface comprises a protective carbon coating comprising graphene, multi-layer graphene, or a combination thereof.

14. The metal of claim 13, wherein at least a portion of the protective carbon coating comprises a single monoatomic layer of graphene.

15. The metal of claim 13, wherein at least a portion of the protective carbon coating comprises a multi-atomic layer and/or multilayers of graphene.

16. The metal of claim 13, wherein the protective carbon coating is electrically conductive.

17. The metal of claim 13, wherein the metal comprises copper, iron, a stainless steel, or an alloy or combination thereof.

18. The metal of claim 13, wherein the metal comprises copper, a copper alloy, or a combination thereof.

19. The metal of claim 13, wherein the protective carbon coating is capable of passivating at least one of corrosion, reactivity, diffusion, or a combination thereof.

20. The metal of claim 13, wherein the protective carbon coating comprises a passivation coating.
